(19) United States
(12) Patent Application Publication
(10) Pub. No.: US 2025/0274877 A1
(43) Pub. Date: Aug. 28, 2025

(54) AUTOMATIC TRANSMIT POWER ADJUSTMENT AT DIFFERENT TEMPERATURES

(71) Applicant: Beken Corporation, Shanghai (CN)

(72) Inventors: Junpeng WU, Shanghai (CN); Qunshan XU, Shanghai (CN); Yexin PENG, Shanghai (CN); Kun DING, Shanghai (CN); Yong LI, Shanghai (CN)

(73) Assignee: Beken Corporation, Shanghai (CN)

(21) Appl. No.: 18/613,978

(22) Filed: Mar. 22, 2024

(30) Foreign Application Priority Data
Feb. 28, 2024 (CN) 202410224914.X

(51) Int. Cl. H04W 52/36; H04L 1/00

(52) U.S. Cl. CPC H04W 52/367; H04L 1/0003

(57) ABSTRACT

The present disclosure provides a system and a method to adjust a transmit power level of a device at different temperatures. The method includes performing a power calibration to determine a preliminary power index; measuring a temperature of the device; obtaining an offset relationship as a function of temperature; determining a target offset value of the device according to the measured temperature and the offset relationship; determining an updated power index based on the preliminary power index and the target offset value; obtaining a transmit power relationship as a function of power index; determining a target transmit power level of the device according to the updated power index and the transmit power relationship; and transmitting data at the target transmit power level.

### CROSS REFERENCE TO RELATED APPLICATION

This application claims priority to and incorporates by reference Chinese patent application no. 202410224914.X filed 28 Feb. 2024.

### TECHNICAL FIELD

The present disclosure generally relates to power adjustment. In particular, example embodiments of the present disclosure address systems and methods for automatically adjusting a transmit power level of a device at different temperatures to maintain its performance.

### BACKGROUND

An Internet of Things (IoT) system includes a network of physical objects, often referred to as “smart devices” or “IoT devices.” These devices are equipped with embedded sensors, software, and other technologies that facilitate connection and data exchange with other devices via networks (e.g., Wi-Fi, Internet). For example, the IoT devices are used in home automation to control lighting, heating and air conditioning, media and security systems, and camera systems.

An access point (AP), such as a router, acts as a central hub for connecting wireless devices (e.g., IoT devices) and routing traffic on the networks. Properly configuring the transmit power of the AP is critical for optimizing the wireless network performance. On one hand, if the transmit power is set too high, it can cause interference with neighboring wireless networks operating in the close frequency band, degrading performance for the AP and neighboring wireless networks. On the other hand, if the transmit power is set too low, wireless devices may experience unstable connections, intermittent drops, and poor throughput. The ideal transmit power level provides the AP with just enough coverage to serve client devices reliably without interfering with neighboring wireless networks.

### SUMMARY

In one aspect, a method to adjust a transmit power level of a device at different temperatures is provided. The method includes performing a power calibration to determine a preliminary power index; measuring a temperature of a device; obtaining an offset relationship as a function of temperature; determining a target offset value of the device according to the measured temperature and the offset relationship; determining an updated power index based on the preliminary power index and the target offset value; obtaining a transmit power relationship as a function of power index; determining a target transmit power level of the device according to the updated power index and the transmit power relationship; and transmitting data at the target transmit power level.

In another aspect, a computing apparatus is provided. The computing apparatus includes a processor and a memory storing instructions. When executed by the processor, the instructions configure the apparatus to: perform a power calibration to determine a preliminary power index; measure a temperature of a device; obtain an offset relationship as a function of temperature; determine a target offset value of the device according to the measured temperature and the offset relationship; determine an updated power index based on the preliminary power index and the target offset value; obtain a transmit power relationship as a function of power index; determine a target transmit power level of the device according to the updated power index and the transmit power relationship; and transmit data at the target transmit power level.

In another aspect, a non-transitory computer-readable storage medium is provided. The computer-readable storage medium includes instructions that when executed by a computer, cause the computer to perform a power calibration to determine a preliminary power index; measure a temperature of a device; obtain an offset relationship as a function of temperature; determine a target offset value of the device according to the measured temperature and the offset relationship; determine an updated power index based on the preliminary power index and the target offset value; obtain a transmit power relationship as a function of power index; determine a target transmit power level of the device according to the updated power index and the transmit power relationship; and transmit data at the target transmit power level.

### BRIEF DESCRIPTION OF THE DRAWINGS

To easily identify the discussion of any particular element or act, the most significant digit or digits in a reference number refer to the figure number in which that element or act is first introduced.

FIG. 1 is a block diagram illustrating an internet of things (IoT) system, in accordance with some example embodiments.

FIG. 2 is a block diagram illustrating an Access Point (AP), in accordance with some example embodiments.

FIG. 3 is an example performance curve of an AP at different temperatures with unadjusted transmit powers, in accordance with some example embodiments.

FIG. 4 is an example offset table, in accordance with some example embodiments.

FIG. 5 illustrates an example relationship between offset value and temperature.

FIG. 6 is an example transmit power table, in accordance with some example embodiments.

FIG. 7 is a flowchart illustrating operations of the AP in determining a target transmit power level, in accordance with some example embodiments.

FIG. 8 is a flowchart illustrating operations of generating an offset relationship, in accordance with some example embodiments.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

As mentioned above, having a suitable transmit power level is important for an AP. It is observed that devices of the same model usually show similar performance drops when the temperature changes, for example, two devices of same model may have a target transmit power level at 10 dBm and 12 dBm at room temperature, respectively. When their temperatures increase to 100° C., the target transmit power levels to maintain their original performance may each be increased by 4.25 dBm, to 14.25 dBm and 16.25 dBm, respectively. In other words, even though the pre-calibrated target transmit power levels of two devices of the same model may be different, the same offset in transmit power levels is used to bring the devices back to their original performance. Therefore, for a same model, a few example devices (e.g., 10 devices) can be tested to determine an average offset relationship that can be used by other devices of the same model to adjust their transmit power levels at different temperatures.

The present disclosure provides systems and methods for automatically adjusting a transmit power level of a device at different temperatures to maintain its performance. First, a power calibration is performed by the device to determine a preliminary power index. The preliminary power index corresponds to a transmit power level associated with a transmit power table. Then, the device periodically or continuously measures a temperature of the device, a component thereof (e.g., a processor, a transceiver), or the surrounding environment. In some examples, the device stores an offset relationship between temperatures and offset values. The offset values indicate how many indexes need to be shifted or offset at the corresponding temperatures. The offset relationship can be a data structure (e.g., a table, a list) of values, such that a target offset value can be determined by searching the data structure based on the measured temperature. Alternatively, the offset relationship can be an equation. In such scenarios, a target offset value can be obtained by inputting the measured temperature into the equation. The preliminary power index can be updated by offsetting it based on the target offset value. In some examples, the device also stores a transmit power relationship between power indexes and transmit power levels. Similar to the offset relationship, the transmit power relationship can be a data structure or an equation. The device determines a target transmit power level by either searching the data structure according to the updated power index or inputting the updated power index in the equation. Finally, the device can adjust its transmit power level to the target transmit power level and transmit data at the target transmit power level.

In some examples, the offset relationship is generated based on tests performed on one or more example devices. The one or more example devices may be of the same model as the device in use. The below example uses one example device to generate the offset relationship, but it should be noted that the offset relationship can also be generated and averaged based on multiple offset relationships corresponding to multiple example devices.

First, the example device is placed in a temperature-controllable apparatus (e.g., a temperature-controlled chamber, an environmental chamber). The temperature of the temperature-controllable apparatus is set to be the same as the room temperature and the example device is controlled to perform a power calibration at the room temperature to determine a reference power index. If multiple example devices are used, the reference power indexes corresponding to the multiple example devices can be averaged. A power calibration is an automatic process in which the example device determines a transmit power level that it may have the best performance. Example power calibration may include selecting a preliminary power index (transmit power level) based on bandwidths, channels, data rates, device capabilities, and network protocols; measuring feedback from the receiver (e.g., signal strength, error rate, Signal to noise ratio (SNR)); and calibrating the preliminary power index based on the feedback.

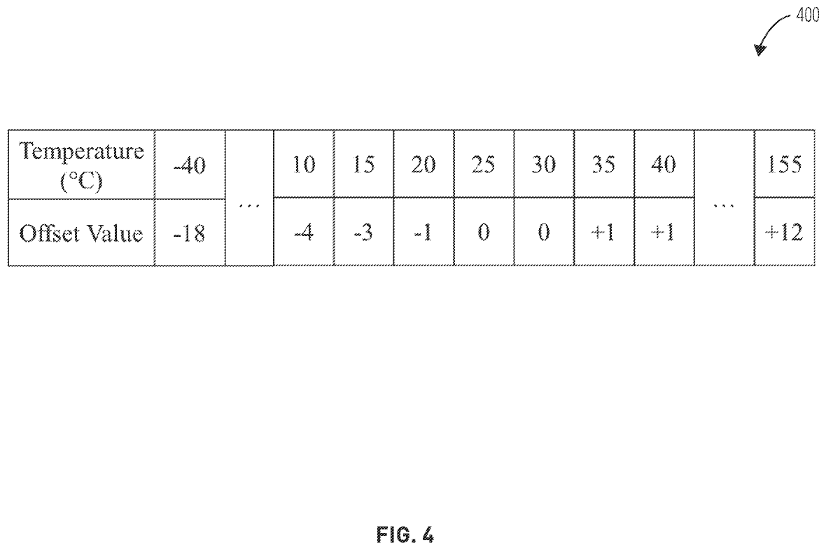

Then, the temperature of the temperature-controllable apparatus can be changed. For example, the temperature is gradually changed from the lowest operating temperature of the example device to the highest operating temperature of the example device. Every time when the temperature is changed by a certain amount (e.g., 5° C., 10° C.), the example device may perform a power calibration to determine a new power index at that temperature. An offset value or shift value is calculated based on the difference between the reference power index at room temperature and the new power index at each of the changed temperatures. An offset relationship is formed based on the temperatures and corresponding offset values. If multiple example devices are used, they can perform the power calibration at the same time and the power indexes at each of the different temperatures can be averaged to determine an average offset value. An example offset relationship may be found in FIG. 4 and descriptions thereof.

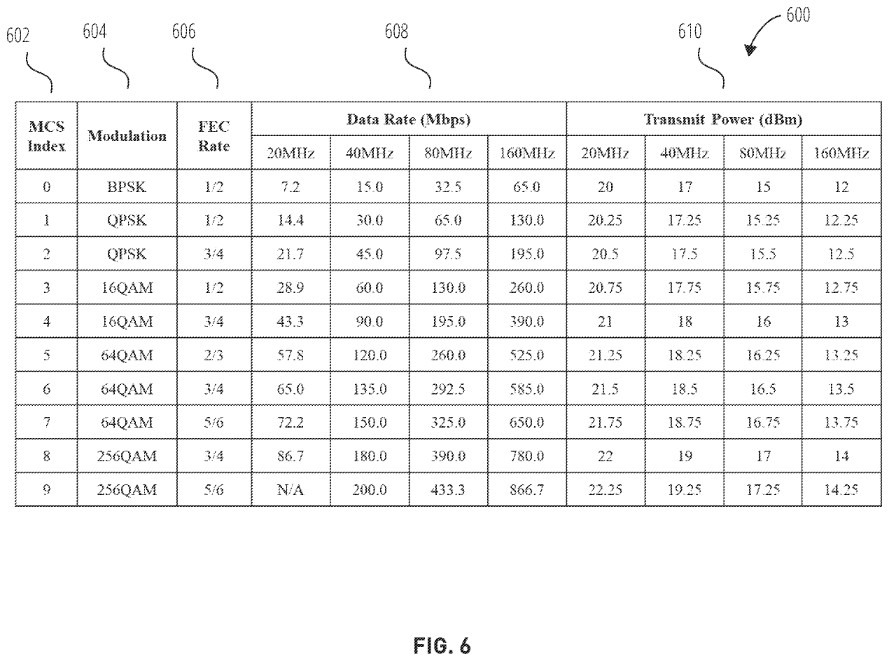

In some examples, the transmit power relationship is predetermined by the manufacturer of the device. The transmit power relationship may be a data structure (e.g., a table, a list) that includes multiple power indexes and multiple corresponding transmit power levels. The transmit power relationship can also be an equation or a graph. In some examples, the transmit power table is a part of or aligned with a Modulation and Coding Scheme (MCS) index table. Specifically, for a device that has selected its protocol, bandwidths, and MCS index, the transmit power level is fixed. An example transmit power table (together with a part of an MCS table under 802.11n with 400 ns guard interval) may be found in FIG. 6 and descriptions thereof. Alternatively, the transmit power level can be independent of the MCS index. In such scenarios, a device can have different power indexes and transmit power levels even with the same MCS index, bandwidths, and protocol.

The present disclosure potentially has at least the following advantages:
1. The transmit power level can be automatically adjusted when the temperature changes.
2. No additional power calibration is required during operation.
3. An offset relationship determined based on example device(s) can be used by all devices of the same model.

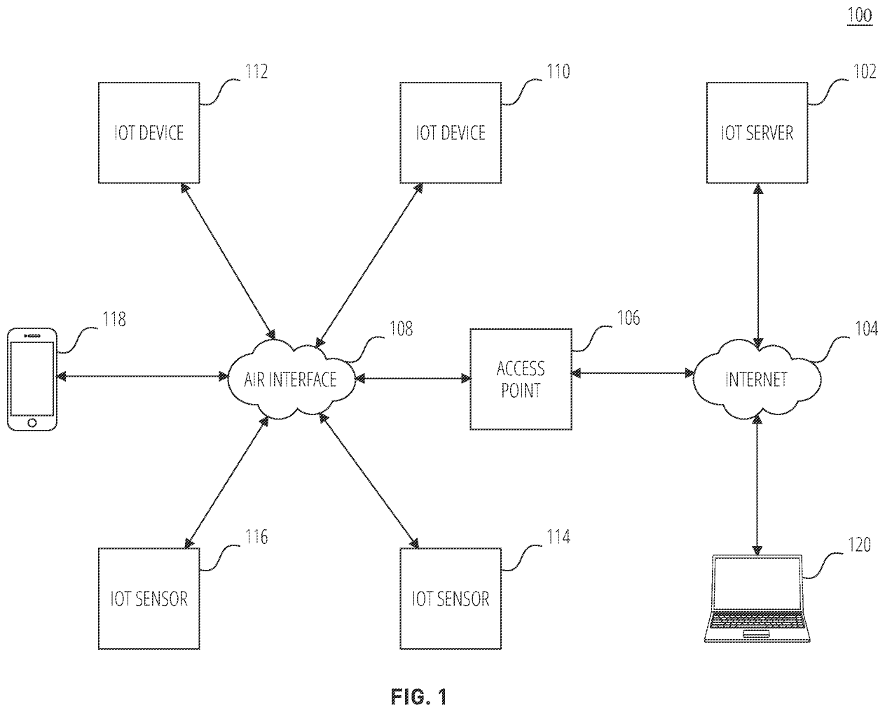

FIG. 1 is a block diagram illustrating an internet of things (IoT) system, in accordance with some example embodiments. The IoT system 100 may include an IoT server 102, a network, such as the Internet 104, an access point 106, an air interface 108, IoT devices 110 and 112, IoT sensors 114 and 116, a mobile device 118, and a monitor device 120.

The IoT server 102 serves as the backbone of the IoT system 100, managing data and coordinating communication among other devices in the IoT system 100. The IoT server 102 collects, processes, and stores data transmitted from IoT devices 110 and 112 and IoT sensors 114 and 116. It also performs tasks such as device management, data analytics, and security enforcement, ensuring smooth operation, and valuable insights from collected data. For example, the IoT server 102 may receive an instruction from the monitor device 120 via the Internet 104 and follow the instruction to manage the IoT device 110 to perform a specific task.

The Internet 104 is a network that allows devices in the IoT system 100 to communicate and exchange data. The Internet 104 provides a pathway for data to travel from IoT devices 110 and 112 and IoT sensors 114 and 116 to the IoT server 102, and vice versa. The Internet 104 also enables remote management, data analysis, and over-the-air updates to the IoT devices. It should be noted that the Internet 104 may be combined with or replaced with other type(s) of network.

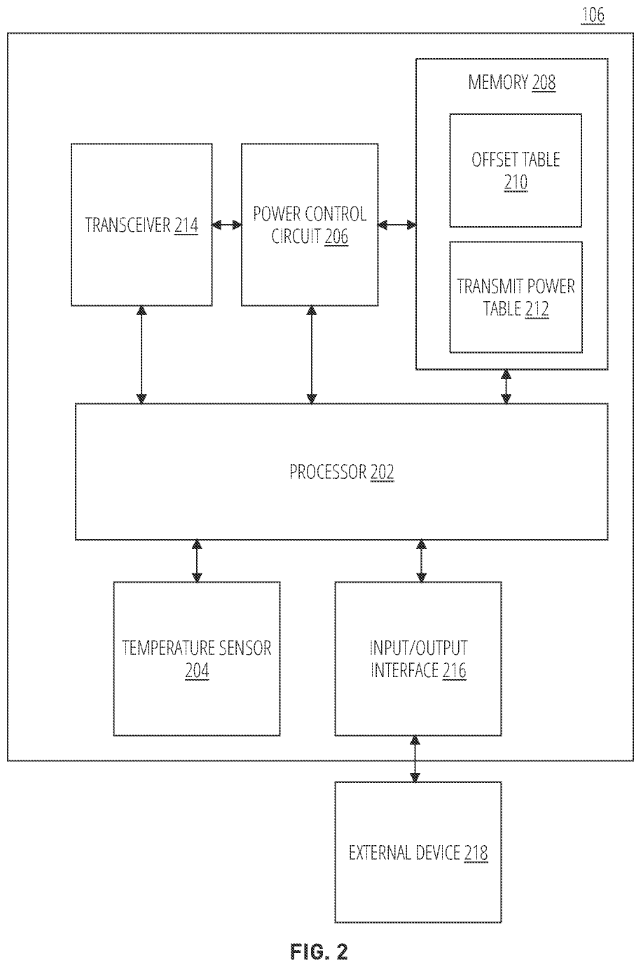

The access point (AP) 106 serves as a bridge between devices (e.g., IoT devices 110 and 112 and IoT sensors 114 and 116) and the Internet 104. It enables devices to connect to the Internet 104 wirelessly, through e.g., Wi-Fi, and facilitates data transfer between these devices and the IoT server 102. Details regarding the AP 106 can be found in FIG. 2 and descriptions thereof.

The air interface 108 refers to the radio frequency spectrum used for wireless communication between the access point 106 and the IoT devices 110 and 112 or IoT sensors 114 and 116. It consists of the standards, protocols, and technologies that define how data is formatted and transmitted wirelessly. For example, the air interface 108 may employ a Wi-Fi network under an IEEE 802.11 standard, such as 802.11a, 802.11b, 802.11g, 802.11n, 802.11ac, 802.11ax, and 802.11be standards. Alternatively, or additionally, the air interface 108 may employ a Bluetooth, a ZigBee, a Z-Wave, a LPWAN, a RFID, a NFC, etc.

The IoT devices 110 and 112 are physical devices, such as appliances, machines, or gadgets, that are equipped with the necessary hardware and software to perform specific tasks. They interact with the IoT sensors 114 and 116 and communicate with the IoT server 102 through the access point 106 and the Internet 104.

The IoT sensors 114 and 116 are devices or modules that detect changes in the environment or system and convert these changes into data that can be understood and used by the IoT devices 110 and 112 or the IoT server 102. These sensors can monitor various parameters, like temperature, humidity, pressure, light, motion, or other environmental factors.

The mobile device 118 is a portable device, such as a smartphone or tablet, that can interact with the IoT system. It can be used to monitor, control, or configure the IoT devices 110 and 112 remotely. It communicates with the IoT server 102 over the Internet 104, allowing users to interact with the IoT system 100 from anywhere.

The monitor device 120 is a device specifically designed to observe and display information from the IoT system. This could be a dedicated display showing data collected by the IoT sensors 114 and 116, or it could be a computer used by system administrators to manage the IoT system 100. It provides real-time or historical data visualization, allowing for effective system monitoring and troubleshooting.

In some examples, the IoT devices 110 and 112 may receive multiple communication requests from devices inside or outside the IoT system 100. For example, the IoT devices 110 and 112 can receive a first signal from the AP 106, a second signal from the IoT sensor 114, and a third signal from a projector outside the IoT system 100.

It should be noted the present disclosure is not limited to an IoT system with a WI-FI network under IEEE 802.11 standard. Instead, the present disclosure may be used in any other same or different types of systems with same or different types of network environment. Such application is within the protective scope of the present disclosure.

FIG. 2 is a block diagram illustrating the AP 106, in accordance with some example embodiments. The AP 106 may include a processor 202, a temperature sensor 204, a power control circuit 206, a memory 208, a transceiver 214, and an input/output interface 216.

The processor 202 is the central processing unit (CPU) that controls the overall operation of the AP 106. It executes firmware and software code to instruct tasks like wireless data transmission/reception, network connectivity, security, transmit power adjustment, power calibration, etc. The processor 202 manages the resources and coordinates communication between components of the AP 106. For example, the processor 202 processes the temperature sensor data obtained from the temperature sensor 204 and determine an offset value based on the processed temperature sensor data and the offset relationship 210. As another example, the processor 202 offsets a preliminary power index determined by the power control circuit 206 by the offset value to generate an updated power index. As a further example, the processor 202 controls the power control circuit 206 to adjust the transmit power to the target transmit power level corresponding to the updated power index.

The temperature sensor 204 continuously or periodically measures the internal temperature of the AP 106 or a component thereof (e.g., the processor 202, the transceiver 214). The temperature sensor 204 may include a thermistor, a thermocouple, or other temperature sensing element. The temperature sensor 204 may convert the sensed temperature into an analog electrical signal. This analog signal is digitized by an analog-to-digital converter into a digital format and is read by the processor 202. The temperature sensor 204 provides real-time temperature data to allow the processor 202 to frequently update the transmit power level as temperature varies. Additionally, or alternatively, the temperature sensor 204 may continuously or periodically measures an environment temperature.

The power control circuit 206 comprises two components: internal power regulation circuitry and transmit power control circuitry. The internal power regulation circuitry regulates and supplies power to the internal components of the AP 106 such as the processor 202, memory 208, etc. The transmit power control circuitry regulates the power supplied specifically to the transceiver 214 to adjust its transmit power level. This circuitry contains digital potentiometers, variable gain amplifiers, switches and other components to accurately control the DC power input to the transceiver 214. The processor 202 programs the transmit power control circuitry to set a target transmit power level according to the updated power index. Based on the control signals from the processor 202, the transmit power control circuitry adjusts the power supplied to the transceiver 214 to precisely match with the desired target transmit power level. This enables real-time adaptation of the wireless transmission power as temperature varies in order to maintain communication quality and performance.

The memory 208 stores firmware, software code, tables, device drivers, and other data used by the processor 202 or other components of the AP 106. The memory 208 may include a non-volatile flash to persist data such as the offset relationship 210 and transmit power relationship 212. The offset relationship 210 stores predetermined offset values indexed by temperatures. The transmit power relationship 212 stores target transmit power levels indexed by power indexes. The offset relationship 210 and the transmit power relationship 212 may include multiple paired binary values. The offset relationship 210 and the transmit power relationship 212 are searchable or employable by the processor 202. The memory 208 may also include fast access storage for the processor 202 during operation, including SRAM for temporary data, registers for status information, ROM for boot code, and EEPROM for device configuration.

The transceiver 214 provides wireless connectivity in the AP 106. The transceiver 214 includes radiofrequency (RF) circuitry to transmit and receive signals over different channels. For example, a transceiver 214 working under an 802.11 Wi-Fi standard may have multiple 2.4 GHz channels and/or multiple 5 GHz channels. The number of channels and their corresponding central frequencies may vary according to the protocol of the wireless communication. The transceiver 214 also enables power calibration. During the power calibration, the transceiver 214 sweeps across different transmit power levels (power indexes, MCS indexes) on assigned channels while receiving feedback from the receiver including signal strength and/or error rates to determine an optimal/target transmit power level. In some examples, the transceiver 214 may receive updated offset table and/or transmit power table from an external device. The processor 202 may then overwrite the updated offset table and/or transmit power table on memory 208.

The input/output interface 216 provides connectivity to external devices 218 that do not have wireless capabilities. It allows the AP 106 to connect to wired peripherals, sensors, controllers and other systems to expand its functionality.

The external device 218 could be any wired accessory, peripheral or even another IoT device that adds functionality through a direct connection. For example, the external device 218 could be an external sensor that provides environmental data, a storage drive that supplies additional memory capacity, another IoT device that performs a certain task, or a control device like a robotic arm that enables automation. The wired connection allows the external device 218 to integrate seamlessly with the AP 106 to expand its capabilities as needed.

While the present disclosure utilizes AP 106 as an exemplary device, it should be understood that other devices with a need to control transmit power may contain some or all of the components described in FIG. 2 and employ the transmit power adjustment techniques disclosed in the present application. The specific teachings using AP 106 as an example are intended to demonstrate the transmit power adjustment concept and should not be interpreted as limiting the disclosure only to APs. Any suitable wireless communication device may adopt the disclosed architecture, components, and methods to achieve similar benefits in managing its own transmit power.

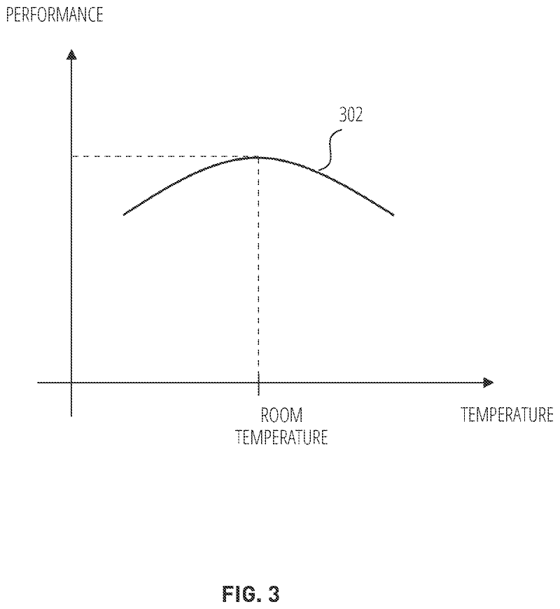

FIG. 3 illustrates an example performance curve 302 of an AP at different temperatures when transmit power is not adjusted. The performance is plotted against temperature in FIG. 3. In some examples, the performance refers to the ability of the AP to reliably transmit data at a desired speed and quality. In some examples, the performance may be quantified based on indicators such as data throughput, error rate, signal strength, signal-to-noise ratio (SNR). However, they are not limiting. Other indicators may also be used.

As shown in FIG. 3, the performance curve 302 peaks at a moderate temperature, such as around room temperature (e.g., 25° C.). Room temperature is defined as the temperature where the AP device is powered on or where initial power calibration is conducted. It should be noted that if the AP device is designed to work at an environment with a higher temperature or a lower temperature, the performance curve 302 may peak at the corresponding environment temperature.

At low temperatures, the performance drops. This is because at low temperatures, the electrical resistance in the circuits of the AP decreases. This results in higher current flow and power consumption for the same transmit power level. To compensate, transmit power should be decreased at low temperatures. If the transmit power is not decreased, the excessive transmit power can cause the error rate to rise due to interferences and distortions.

At high temperatures, the performance also drops. This is because at high temperatures, the electrical resistance in the AP's circuits increases, resulting in lower current and insufficient power. Thus, transmit power needs to be increased at high temperatures to provide adequate power to maintain performance. If the transmit power is not increased, the insufficient transmit power can cause signal strength and data throughput to decrease.

As temperature deviates further from the room temperature, performance declines more notably if transmit power is not adjusted. To maintain peak performance across a wide temperature range, transmit power level should generally be decreased at colder temperatures and increased at hotter temperatures relative to the power level calibrated at room temperature.

FIG. 4 is an example offset table 400, in accordance with some example embodiments. The offset table 400 shows an example set of temperatures and corresponding offset values that can be used to adjust transmit power based on temperature variations. The offset values represent the difference in power index at each temperature compared to a reference power index calibrated at room temperature.

For example, at very low temperatures such as −40° C., the offset is −18, indicating that transmit power index needs to be reduced by 18 indexes compared to the room temperature calibration to avoid excessive power. At very high temperatures such as +155° C., the offset is +12, indicating that transmit power index needs to be increased by 12 indexes to compensate for insufficient power at high temperatures. The indexes refer to the indexes in a transmit power table (e.g., transmit power table 600).

The offset table could be generated by an example AP performing power calibrations across a range of temperatures to quantify the offset at each temperature relative to room temperature. In operation, the AP may search a stored offset table to periodically adjust its transmit power based on current temperature measurements during operation. If the AP cannot find a value in the offset table, it may find the closest available temperature in the offset table and adjust to the transmit power level corresponding to that temperature. In some examples, in order to avoid excessive transmit power (which is likely more detrimental than insufficient power), the AP can adjust to the transmit power level corresponding to the closest available temperature that is below the measured temperature.

It should be noted that the values in the example offset and MCS tables may vary across different AP models and manufacturers. The offset table 400 provided herein is for illustration only and do not necessarily reflect real-world relationships. Environmental factors and hardware differences also impact the offset values and power levels in practice.

It should also be noted that offset table 400 is merely an exemplary format of the offset relationship. The offset relationship can be in another format, such as a list, an equation, a graph. For example, the offset relationship can be expressed as an equation below:

$$Offset value = \{ \begin{matrix}⌊ ( ( T - 25 ) * 0.277 ) ⌉ & T < 25 \\ ⌊ ( ( T - 25 ) * 0.09 ) ⌉ & T \geq 25\end{matrix} \qquad ( 1 )$$

where T denotes the measured temperature, └ ┐ is a round operator that rounds the number inside to a nearest integer. The equation (1) can be stored in the memory 208 as the offset relationship 210. A processor (e.g., processor 202) may input a measured temperature into the equation (1) to obtain an offset value.

The equation (1) is merely exemplary and can be modified as needed. As long as the modified equation establishes a relationship between offset values and temperatures, it is within the protection scope of the present disclosure.

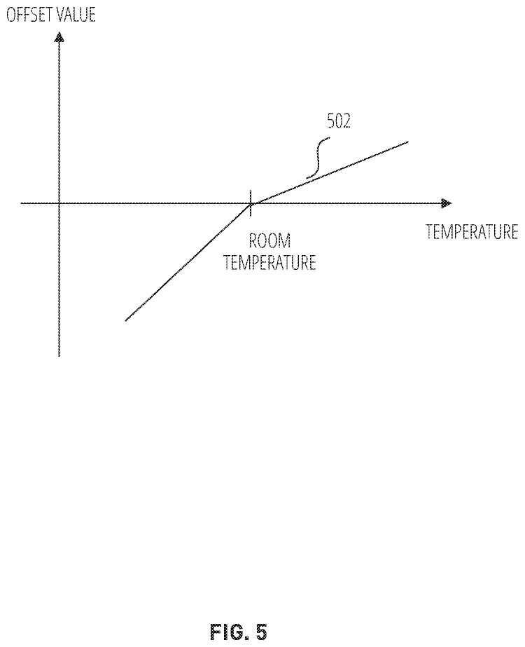

FIG. 5 illustrates an example relationship between offset value and temperature. As shown in FIG. 5, the offset may vary with temperature in an approximately linear manner. However, the relationship may also follow a nonlinear curve or have discrete steps (e.g., like sparse points) between temperatures. The plot 502 is merely for the purpose of illustration. In some examples, the plot 502 is a graphical format of the offset relationship 210 and can be stored in the memory 208. Specifically, the plot 502 has temperature measurements plotted along the x-axis and offset values plotted along the y-axis. To determine an offset value for a measured temperature, a processor (e.g., processor 202) can input the measured temperature as an x-axis value on the graph and then determine the corresponding y-axis value as the offset value.

The plot 502 shows how the offset value changes as the temperature increases. The offset represents the difference in transmit power index between the current temperature and the reference room temperature calibration. At low temperatures, the offset is negative, indicating that transmit power should be reduced below the room temperature calibration. As temperature increases, the offset increases towards zero. Near room temperature, the offset is zero because the device is calibrated at this reference point. As temperature continues rising, the offset becomes positive, indicating that transmit power needs to be increased above the calibrated level. The plot 502 generally demonstrates how transmit power should be continually adjusted versus the baseline room temperature calibration to maintain performance across temperatures.

FIG. 6 is an example transmit power table 600, in accordance with some example embodiments. The transmit power table 600 also includes a part of a Modulation and Coding Scheme (MCS) index table under 802.11n with 400 ns guard interval.

The MCS indexes in column 602 range from 0 to 7, representing a small subset (the first spatial stream) of the indices defined in IEEE 802.11n standard. The full 802.11n standard defines indexes up to 23, with each index specifying a unique modulation format (in column 604) and Forward Error Correction (FEC) rate (in column 606). Within each spatial stream (e.g., 8 or 10 indexes), higher index values generally correspond to higher modulations that enable faster data rates. More advanced 802.11 standards also define additional modulations (e.g., 256-QAM, 1024-QAM, 4096-QAM) not shown here but the concept is similar.

The FEC rate in column 606 specifies the proportion of redundant data added to the transmission to provide error correction capabilities. Higher FEC rates have less redundancy and thus higher throughput. Column 608 provides the data rates achievable using each MCS

index, FEC rate, and channel bandwidth. The bandwidths shown range from 20 MHz to 160 MHz under 802.11n standard. Newer standards like 802.11be support even wider bandwidths up to 320 MHz, enabling data rates over 2.8 Gbps. Generally, wider bandwidths allow for higher throughput at a given MCS index.

The transmit power levels in column 610 show the target power level at a corresponding index, FEC rate, and bandwidth. In some examples, a higher bandwidth corresponds to a smaller target transmit power at the same index. Additionally, the table demonstrates that an increase of 1 in the MCS index results in approximately a 0.25 dBm increase in the target transmit power level for a given bandwidth.

During operation, after the AP determines its updated MCS index, the AP searches the transmit power table 600 to find the target transmit power for that index at the current bandwidth. Then the AP adjusts its transmit power level to the target transmit power and transmit data at that power level.

It should be noted that the above example aligns the MCS index with the power index, however, the AP can have a power index separated from the MCS index. In such scenarios, the AP can have different power indexes and transmit power levels even with the same MCS index, channel, and protocol.

It should also be noted that transmit power table 600 is merely an exemplary format of the transmit power relationship. The transmit power relationship can be in another format, such as a list, an equation, a graph. For example, the transmit power relationship can be expressed as an equation below:

$$Transmit power = \{ \begin{matrix}20 + 0.25 * power index & bandwidth = 20 MHz \\ 17 + 0.25 * power index & bandwidth = 40 MHz \\ 15 + 0.25 * power index & bandwidth = 80 MHz \\ 12 + 0.25 * power index & bandwidth = 160 MHz\end{matrix} \qquad ( 2 )$$

The equation (2) can be stored in the memory 208 as the transmit power relationship 212. A processor (e.g., processor 202) may input a power index into the equation (1) to obtain a transmit power.

The equation (2) is merely exemplary and can be modified as needed. As long as the modified equation establishes a relationship between power indexes and transmit power levels, it is within the protection scope of the present disclosure.

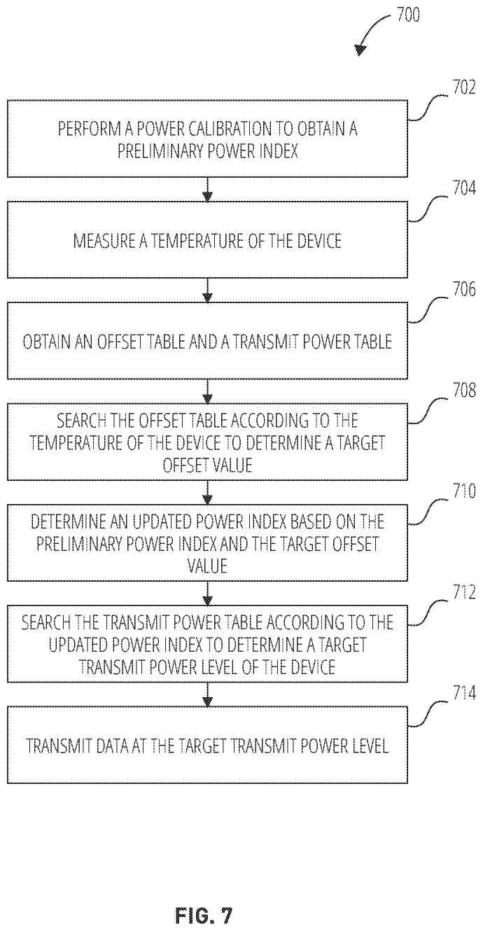

FIG. 7 is a flowchart illustrating operations of the AP in determining a target transmit power level, in accordance with some example embodiments. The method 700 may be embodied in computer-readable instructions for execution by one or more processors such that operations of the method 700 may be performed in part or in whole by the functional components of the AP 106; accordingly, the method 700 is described below by way of example with reference thereto. However, it shall be appreciated that at least some of the operations of the method 700 may be deployed on various other hardware configurations than the AP 106. Also, the operations of the method 700 may be partially omitted, or performed in any order.

In operation 702, the AP 106 performs a power calibration to obtain a preliminary power index. A power calibration is an automatic process in which the example device determines a transmit power level that it may have the best performance. Example power calibration may include selecting a preliminary power index (transmit power level) based on channels, data rates, device capabilities, and network protocols; measuring feedback from the receiver (e.g., signal strength, error rate, Signal to noise ratio (SNR)); and calibrating the preliminary power index based on the feedback.

In operation 704, the AP 106 measures its temperature. The temperature of the AP 106 may refer to the temperature of a component thereof (e.g., processor 202, transceiver 214), or an environment temperature. The temperature can be measured by the temperature sensor 204. The AP 106 may continuously or periodically measure its temperature. In some examples, in order to save power, the remaining operations in method 700 is performed only when the difference between the temperature at the measuring moment and the reference temperature (or the temperature from the last measurement) is greater than a threshold. Alternatively, the remaining operations in method 700 is performed whenever the measured temperature is different from the reference temperature (or the temperature from the last measurement). Merely by way of example, the AP 106 measures its temperature every second during the first two minutes after powering up and every 15 seconds afterwards.

In operation 706, the AP 106 obtains an offset relationship and a transmit power relationship. For example, the AP 106 reads prestored offset relationship (e.g., offset relationship 210) and transmit power relationship (e.g., transmit power relationship 212) from a memory (e.g., memory 208). An offset relationship may include a relationship between temperatures and offset values. The offset values indicate how many indexes need to be shifted or offset at the corresponding temperatures. The offset relationship can be in a format of a table (e.g., offset table 400), a graph (e.g., plot 502), a list, an equation (e.g., equation (1). However, the offset relationship can also be in other formats and is not limiting here. A transmit power relationship may include a relationship between power indexes and target transmit power levels. The transmit power relationship may be a part of or aligned with a Modulation and Coding Scheme (MCS) index table. In such scenarios, the AP 106's power index is the same as the MCS index. Alternatively, the transmit power relationship is an independent relationship with its unique indexes. The transmit power relationship can be in a format of a table (e.g., transmit power table 600), a graph, a list, an equation (e.g., equation (2). However, the transmit power relationship can also be in other formats and is not limiting here.

In operation 708, the AP 106 determines a target offset value according to the measured temperature and the offset relationship. For example, if the temperature is 40° C., the AP 106 may search the offset table 400 or input the 40° C. into equation (1) to determine the target offset value to be +1.

In operation 710, the AP 106 determines an updated power index based on the preliminary power index and the target offset value. For example, if the preliminary power index is 3, the updated power index may be determined to be 3+(+1)=4.

In operation 712, the AP 106 determines a target transmit power level of the AP 106 according to the updated power index and the transmit power relationship. For example, if the bandwidth is 20 MHz, the AP 106 may search the transmit power table 600 or input 4 (updated power index) into the equation (2) to determine that the target transmit power level of the AP is 21 dBm.

In operation 714, the AP 106 transmit data at the target transmit power level. Specifically, the power control circuit 206 of the AP 106 may regulates the power supplied specifically to the transceiver 214 to adjust its transmit power level to be 21 dBm.

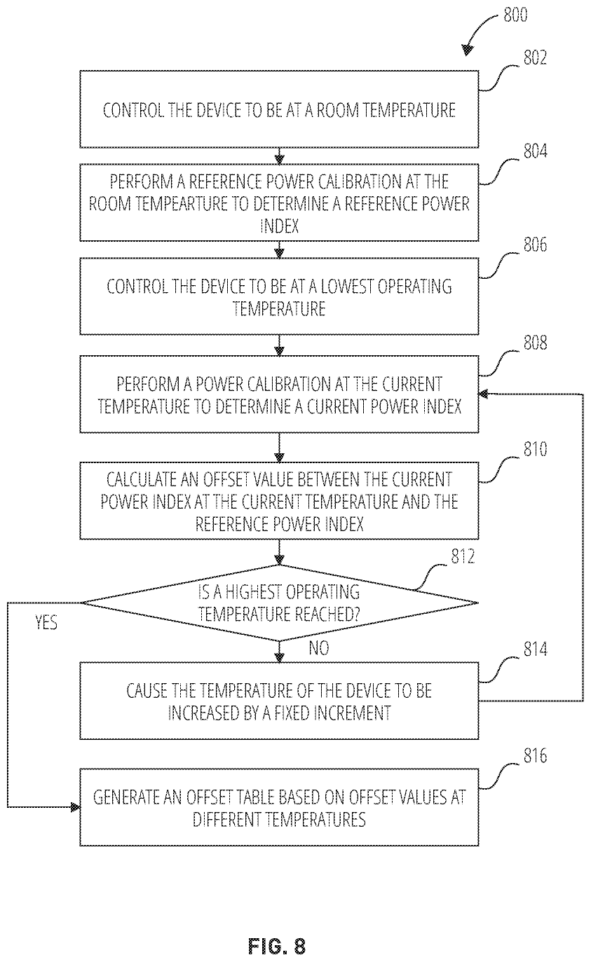

FIG. 8 is a flowchart illustrating operations of generating an offset relationship, in accordance with some example embodiments. The method 800 may be embodied in computer-readable instructions for execution by one or more processors such that operations of the method 800 may be performed in part or in whole by the functional components of any internal or external processing units of the AP 106. However, it shall not be limiting. It is possible that method 800 is performed by a computer in a testing center of the manufacturer of the AP 106. Also, the operations of the method 800 may be partially omitted, or performed in any order.

In operation 802, at least one example device is controlled to be at a room temperature. In some examples, the at least one example device is placed in a temperature-controlled apparatus (e.g., temperature-controlled chamber, environmental chamber) and the temperature-controlled apparatus keeps its internal temperature at the room temperature. Alternatively, the at least one example device is just placed outside at a room temperature for a certain duration.

In operation 804, the at least one example device is controlled to perform a reference power calibration at the room temperature to determine a reference power index.

In operation 806, the at least one example device is controlled to be at a lowest operating temperature. For example, the temperature-controlled apparatus can adjust its internal temperature to the lowest operating temperature of the at least one example device. In some examples, the lowest operating temperature is −40° C. However, this is not limiting.

In operation 808, the example device performs a power calibration at the current temperature (e.g., the lowest operating temperature in the first iteration and a current temperature in following iterations) to determine a current power index.

In operation 810, an offset value is calculated between the current power index determined at the current temperature and the reference power index determined at the room temperature.

In operation 812, the processing units may determine whether a highest operating temperature of the at least one example device is reached.

In response to a determination that the highest operating temperature of the example device is reached, the method 800 proceeds to operation 816; otherwise, the method 800 proceeds to 814. In some examples, the highest operating temperature of the at least one example device is +105° C., but this is not limiting.

In some examples, the at least one example temperature can be controlled to be lower than the lowest operating temperature in operation 806 and the determination in operation 812 can be satisfied only when a temperature (e.g., +155° C.) higher than the highest operating temperature is reached. This may provide the device some robustness against extreme condition.

In operation 814, the temperature of the example device is increased, e.g., by a fixed increment. The fixed increment can be 1° C., 2° C., or 5° C. and is not limiting. When the temperature after increment is reached, the method 800 proceeds back to 808 and the next iteration begins. Specifically, in the next iteration, the power calibration is performed to determine a current power index corresponding to the increased temperature. After iteratively increasing the temperature and calibrating the example device, offset values of the example device at different temperatures can be obtained.

In operation 816, an offset table (or an offset list) is generated. The offset table establishes a one-to-one relationship between offset values and temperatures. An example offset table can be found in FIG. 4 and descriptions thereof.

The at least one example device may include a single example device or multiple example devices (e.g., 5, 10, 50, 100 devices). When multiple example devices are used, values in the offset table or any intermediate values can be averaged. In order to avoid excessive transmit power (which is likely more detrimental than insufficient power), the offset value in the offset table can be increased by a small preset number such that the adjusted transmit power will be slightly lower than optimal transmit power level. In some examples, the at least one example device may all have the same model or model number as the AP 106.

Optionally, an offset equation (e.g., equation (1)) is generated. In scenarios that the relationship between offset values and temperatures is linear or fits into a curve, the offset equation can be generated as a shorter format of the offset table generated in operation 816. Specifically, the AP 106 may employ a curve fitting algorithm or an Artificial Intelligence (AI) model to generate the offset equation. In scenarios that the relationship between offset values and temperatures is non-linear or does not fit into a curve, this offset equation may be omitted.

In some examples, operation 816 is omitted and the offset equation is obtained directly based on the offset values and temperatures.

In some examples, the at least one example device can be controlled by an automatic system to independently or concurrently undergo the method 800. In some other examples, the AP 106 can be controlled by an automatic system to undergo the method 800 such that the AP 106 (and each AP) may have their own offset table. This method is generally more accurate but expensive and time consuming but could be done by the automatic system.

In some examples, the offset table (e.g., offset table 400) is associated with a specific reference temperature at which the device (e.g., AP 106) boots up and performs the preliminary power calibration. For instance, the offset table 400 may correspond to a reference temperature of 25° C. Often, the device boots at this reference temperature. Subsequently, as the device's temperature changes, the offset is determined using the offset table, and the index is adjusted accordingly. However, there may be instances where the device's boot-up temperature differs from the reference temperature. In such cases, an offset table corresponding to the actual boot-up temperature should be utilized. In some examples, multiple offset tables are created for different boot-up temperatures, and the appropriate offset table is selected based on the actual boot-up temperature. Alternatively, the offset table 400, which corresponds to the 25° C. reference temperature (“25° C. offset table”), may be adapted when the boot-up temperature is different from the reference temperature of 25° C. The adaptations can involve scaling the offsets in the 25° C. offset table by a coefficient and/or adjusting the offsets based on the new boot-up temperature. For example, for every 5 degrees that the boot-up temperature exceeds the reference temperature (e.g., 25° C.), the index offset might be reduced by 1; for every 5 degrees that the boot-up temperature is below the reference temperature (e.g., 25° C.), the index offset might be increased by 1. However, it should be noted that other ways of adaptations are possible.

It should be noted that although the present method is primarily used to adjust transmit power of the AP 106, other parameters (e.g., current, voltage, frequency) of the AP 106 may also shift when the temperature changes. Such parameters can affect the performance of the AP 106 as well and may be adjusted using the method of present disclosure under limited modifications. Such modified method is also within the protection scope of the present disclosure.

### Examples

1. A method to adjust a transmit power level of a device at different temperatures, the method comprising:
   performing a power calibration to determine a preliminary power index;
   measuring a temperature of the device;
   obtaining an offset relationship as a function of temperature;
   determining a target offset value of the device according to the measured temperature and the offset relationship;
   determining an updated power index based on the preliminary power index and the target offset value;
   obtaining a transmit power relationship as a function of power index;
   determining a target transmit power level of the device according to the updated power index and the transmit power relationship; and
   transmitting data at the target transmit power level.
2. The method of example 1, wherein the offset relationship is generated by operations comprising:
   performing a first power calibration at a reference temperature to determine a reference power index;
   performing a set of second power calibrations at a set of temperatures to determine a set of power indexes;
   determining a set of offset values based on differences between the reference power index and the set of power indexes; and
   generating the offset relationship based on the set of temperatures and the set of offset values.
3. The method of example 2, wherein the reference temperature is a room temperature.
4. The method of any of examples 2-3, wherein the set of temperatures include operating temperatures of the device.
5. The method of any of examples 2-4, wherein the device is a first device, and the offset relationship is generated by a second device, the first device and the second device having a same model.
6. The method of any of examples 1-5, wherein the power calibration is performed when the device is powered on and the temperature of the device is measured when the device is in operation.
7. The method of any of examples 1-6, wherein the transmit power relationship incorporates at least part of a Modulation and Coding Scheme (MCS) index table of the device.
8. The method of any of examples 1-7, wherein the temperature of the device does not match with any temperature of the set of temperatures in the offset relationship and the determining of the target offset value of the device according to the measured temperature comprises:
   determining a target temperature among the set of temperatures in the offset relationship that is closest to the temperature of the device; and
   determining the target offset value of the device according to the target temperature and the offset relationship.
9. The method of any of examples 1-8, further comprising:
   receiving an updated offset relationship;
   determining an updated target offset value according to the measured temperature and the updated offset relationship;
   updating the preliminary power index based on the updated target offset value;
   determining an updated target transmit power level according to the updated power index and the transmit power relationship; and
   transmitting the data at the updated target transmit power level.
10. The method of any of examples 1-9, wherein the offset relationship is a data structure or an equation.
11. A computing apparatus comprising:
   a processor; and
   a memory storing instructions that, when executed by the processor, configure the apparatus to:
   perform a power calibration to determine a preliminary power index;
   measure a temperature of a device;
   obtain an offset relationship as a function of temperature;
   determine a target offset value of the device according to the measured temperature and the offset relationship;
   determine an updated power index based on the preliminary power index and the target offset value;
   obtain a transmit power relationship as a function of power index;
   determine a target transmit power level of the device according to the updated power index and the transmit power relationship; and
   transmit data at the target transmit power level.
12. The computing apparatus of example 11, wherein the offset relationship is generated by operations comprising:
   perform a first power calibration at a reference temperature to determine a reference power index;
   perform a set of second power calibrations at a set of temperatures to determine a set of power indexes;
   determine a set of offset values based on differences between the reference power index and the set of power indexes; and
   generate the offset relationship based on the set of temperatures and the set of offset values.
13. The computing apparatus of example 12, wherein the reference temperature is a room temperature.
14. The computing apparatus of any of examples 12-13, wherein the set of temperatures include operating temperatures of the device.
15. The computing apparatus of any of examples 12-14, wherein the device is a first device, and the offset relationship is generated by a second device, the first device and the second device having a same model.
16. The computing apparatus of any of examples 11-15, wherein the power calibration is performed when the device is powered on and the temperature of the device is measured when the device is in operation.
17. The computing apparatus of any of examples 11-16, wherein the transmit power relationship incorporates at least part of a Modulation and Coding Scheme (MCS) index table of the device.
18. The computing apparatus of any of examples 11-17, wherein the temperature of the device does not match with any temperature of the set of temperatures in the offset relationship and to determine the target offset value of the device according to the measured temperature, the instructions configure the apparatus to:
   determine a target temperature among the set of temperatures in the offset relationship that is closest to the temperature of the device; and
   determine the target offset value of the device according to the target temperature and the offset relationship.
19. The computing apparatus of any of examples 11-18, wherein the instructions further configure the apparatus to:
   receive an updated offset relationship;
   determine an updated target offset value according to the measured temperature and the updated offset relationship;
   update the preliminary power index based on the updated target offset value;
   determine an updated target transmit power level according to the updated power index and the transmit power relationship; and
   transmit the data at the updated target transmit power level.
20. A non-transitory computer-readable storage medium, the computer-readable storage medium including instructions that when executed by a computer, cause the computer to:
   perform a power calibration to determine a preliminary power index;
   measure a temperature of a device;
   obtain an offset relationship as a function of temperature;
   determine a target offset value of the device according to the measured temperature and the offset relationship;
   determine an updated power index based on the preliminary power index and the target offset value;
   obtain a transmit power relationship as a function of power index;
   determine a target transmit power level of the device according to the updated power index and the transmit power relationship; and
   transmit data at the target transmit power level.

### CONCLUSION

The present disclosure provides systems and methods for automatically adjusting a transmit power level of a device at different temperatures to maintain its performance.

During a development stage, example device(s) boot up and perform power calibration at a reference temperature (e.g., 25° C.). Specifically, with devices powered on after initial 25° C. calibration, transmit power is measured at a 5° C. temperature increment from −40° C. to 155° C. and compared to 25° C. transmit power to generate a “25° C. offset table,” indicating the offset needed at each temperature when the device boots up at 25° C. In some examples, the transmit power level can only be measured during the development stage but not the usage stage. In other words, the transmit power level is unknown to the device during use. However, the device can increase or decrease its transmit power level by changing its index based on the offset table. Under Wi-Fi 802.11b standard, an increase of 1 in the power index corresponds to approximately 0.5 dBm increase in the transmit power level. Under other Wi-Fi standards, such as 802.11g, 802.11n, 802.11ac, and 802.11ax, an increase of 1 in the power index corresponds to approximately 0.25 dBm increase in the transmit power level.

The example devices can also boot up at other temperatures. A similar process can be performed to increase the temperature from −40° C. to 155° C. to generate an offset table corresponding to each boot-up temperature (e.g., a 10° C. offset table, a 40° C. offset table, etc.). Alternatively, a relationship between the 25° C. offset table and offset table at other boot-up temperatures can be determined and used. For example, it could be observed that for every 5 degrees that the boot-up temperature exceeds the reference temperature (e.g., 25° C.), the index offset might be reduced by 1; for every 5 degrees that the boot-up temperature is below the reference temperature (e.g., 25° C.), the index offset might be increased by 1.

During a usage stage, a device performs an initial power calibration at a boot-up temperature to determine preliminary indexes. The device may look up an offset table that corresponds to the boot-up temperature. If the device boots up at 25° C., it may periodically measure temperature and look up the default 25° C. offset table based on the measured temperature to determine an offset to the preliminary indexes.

If, however, the device boots up at a temperature different from reference temperature, e.g., 10° C., it may directly use a 10° C. offset table or use the 25° C. offset table but with adaptions. Specifically, if a relationship between the 10° C. offset table and the 25° C. offset table is stored, the device may measure its temperature periodically, look up the 25° C. offset table, and further adjust the offset corresponding to the measured temperature based on the relationship between the 10° C. offset table and the 25° C. offset table. Merely by way of example, if the device boots up at 10° C. and the measured temperature is 40° C., the offset can be determined to be +1 (read directly from 25° C. offset table)+3 (relationship between 10° C. offset table and 25° C. offset table)=+4.

The device can then use the offset to adjust the preliminary indexes to dynamically tune its transmit power to maintain consistent performance across a wide temperature range without needing continuous recalibration.

The present disclosure potentially has at least the following advantages:
1. The transmit power level can be automatically adjusted when the temperature changes.
2. No additional power calibration is required during operation.
3. An offset relationship determined based on example device(s) can be used by all devices of the same model.

What is claimed is:

1. A method to adjust a transmit power level of a device at different temperatures, the method comprising:
performing a power calibration to determine a preliminary power index;
measuring a temperature of the device;
obtaining an offset relationship as a function of temperature;
determining a target offset value of the device according to the measured temperature and the offset relationship;
determining an updated power index based on the preliminary power index and the target offset value;
obtaining a transmit power relationship as a function of power index;
determining a target transmit power level of the device according to the updated power index and the transmit power relationship; and
transmitting data at the target transmit power level.

2. The method of claim 1, wherein the offset relationship is generated by operations comprising:
performing a first power calibration at a reference temperature to determine a reference power index;
performing a set of second power calibrations at a set of temperatures to determine a set of power indexes;
determining a set of offset values based on differences between the reference power index and the set of power indexes; and
generating the offset relationship based on the set of temperatures and the set of offset values.

3. The method of claim 2, wherein the reference temperature is a room temperature.

4. The method of claim 2, wherein the set of temperatures include operating temperatures of the device.

5. The method of claim 2, wherein the device is a first device, and the offset relationship is generated by a second device, the first device and the second device having a same model.

6. The method of claim 1, wherein the power calibration is performed when the device is powered on and the temperature of the device is measured when the device is in operation.

7. The method of claim 1, wherein the transmit power relationship incorporates at least part of a Modulation and Coding Scheme (MCS) index table of the device.

8. The method of claim 1, wherein the temperature of the device does not match with any temperature of the set of temperatures in the offset relationship and the determining of the target offset value of the device according to the measured temperature comprises:
determining a target temperature among the set of temperatures in the offset relationship that is closest to the temperature of the device; and
determining the target offset value of the device according to the target temperature and the offset relationship.

9. The method of claim 1, further comprising:
receiving an updated offset relationship;
determining an updated target offset value according to the measured temperature and the updated offset relationship;
updating the preliminary power index based on the updated target offset value;
determining an updated target transmit power level according to the updated power index and the transmit power relationship; and
transmitting the data at the updated target transmit power level.

10. The method of claim 1, wherein the offset relationship is a data structure or an equation.

11. A computing apparatus comprising:
a processor; and
a memory storing instructions that, when executed by the processor, configure the apparatus to:
perform a power calibration to determine a preliminary power index;
measure a temperature of a device;
obtain an offset relationship as a function of temperature;
determine a target offset value of the device according to the measured temperature and the offset relationship;
determine an updated power index based on the preliminary power index and the target offset value;
obtain a transmit power relationship as a function of power index;
determine a target transmit power level of the device according to the updated power index and the transmit power relationship; and
transmit data at the target transmit power level.

12. The computing apparatus of claim 11, wherein the offset relationship is generated by operations comprising:
perform a first power calibration at a reference temperature to determine a reference power index;
perform a set of second power calibrations at a set of temperatures to determine a set of power indexes;
determine a set of offset values based on differences between the reference power index and the set of power indexes; and
generate the offset relationship based on the set of temperatures and the set of offset values.

13. The computing apparatus of claim 12, wherein the reference temperature is a room temperature.

14. The computing apparatus of claim 12, wherein the set of temperatures include operating temperatures of the device.

15. The computing apparatus of claim 12, wherein the device is a first device, and the offset relationship is generated by a second device, the first device and the second device having a same model.

16. The computing apparatus of claim 11, wherein the power calibration is performed when the device is powered on and the temperature of the device is measured when the device is in operation.

17. The computing apparatus of claim 11, wherein the transmit power relationship incorporates at least part of a Modulation and Coding Scheme (MCS) index table of the device.

18. The computing apparatus of claim 11, wherein the temperature of the device does not match with any temperature of the set of temperatures in the offset relationship and to determine the target offset value of the device according to the measured temperature, the instructions configure the apparatus to:
determine a target temperature among the set of temperatures in the offset relationship that is closest to the temperature of the device; and
determine the target offset value of the device according to the target temperature and the offset relationship.

19. The computing apparatus of claim 11, wherein the instructions further configure the apparatus to:
receive an updated offset relationship;
determine an updated target offset value according to the measured temperature and the updated offset relationship;
update the preliminary power index based on the updated target offset value;
determine an updated target transmit power level according to the updated power index and the transmit power relationship; and
transmit the data at the updated target transmit power level.

20. A non-transitory computer-readable storage medium, the computer-readable storage medium including instructions that when executed by a computer, cause the computer to:
perform a power calibration to determine a preliminary power index;
measure a temperature of a device;
obtain an offset relationship as a function of temperature;
determine a target offset value of the device according to the measured temperature and the offset relationship;
determine an updated power index based on the preliminary power index and the target offset value;
obtain a transmit power relationship as a function of power index;
determine a target transmit power level of the device according to the updated power index and the transmit power relationship; and
transmit data at the target transmit power level.
